(19) United States
(12) Patent Application Publication
(10) Pub. No.: US 2010/0306210 A1
(43) Pub. Date: Dec. 2, 2010

(54) CLUSTERING IDENTICAL OR DISJOINT KEYWORD SETS FOR USE WITH AUCTIONS FOR ONLINE ADVERTISING SPACE

(75) Inventors: Grant Wang, Mountain View, CA (US); Mohammad Mahdian, Santa Clara, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo., Inc., a Delaware corporation, Sunnyvale, CA (US)

(21) Appl. No.: 12/471,832

(22) Filed: May 26, 2009

(51) Int. Cl. G06F 17/30

(52) U.S. Cl. 707/759; 707/708; 707/737

(57) ABSTRACT

Embodiments of methods, apparatuses, or systems relating to clustering identical or disjoint keyword sets for use with auctions for online advertising space.

### BACKGROUND

1. Field

The subject matter disclosed herein relates to clustering identical or disjoint keyword sets for use with auctions for online advertising space.

2. Information

Advertising markets for online advertising space, such as sponsored search markets, may provide a marketplace where advertisers can bid for millions of advertising opportunities to promote their products. Search engine companies, or other market makers, run today's largest auction houses for online advertising space, selling millions of advertising opportunities to hundreds of thousands of advertisers every day.

While these markets are commonplace, advertising markets for online advertising space may present particular concerns in contrast to more traditional markets for advertising space. For example, existing mechanisms and/or approaches useful for markets for online advertising space may produce, or result in, undesirable economic conditions for one or more market participants. Markets may not have an equilibria (e.g., Nash equilibrium) or may lack coverage of various keywords that may be valuable, as just a few examples. Thus, other mechanisms and/or approaches may be desirable.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a schematic diagram depicting an illustrative embodiment of an exemplary system that may be enabled to implement or support a market for online advertising space capable of producing a dominant advertiser strategy.

FIG. 2 is a schematic diagram depicting an illustrative embodiment of an exemplary apparatus to implement or support a market for online advertising space capable of producing a dominant advertiser strategy.

FIG. 3 is a flow chart depicting an illustrative embodiment of a method for implementing or supporting a market for online advertising space capable of producing a dominant advertiser strategy.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some portions of the detailed description which follow are presented in terms of algorithms or symbolic representations of operations on binary digital signals which may be stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

The terms, “and,” “and/or,” and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. Reference throughout this specification to “one embodiment” or “an embodiment” or a “certain embodiment” means that a particular feature, structure, or characteristic described in connection with the embodiment is included in at least one embodiment of claimed subject matter. Thus, the appearances of the phrase “in one embodiment” or “an embodiment” or a “certain embodiment” in various places throughout this specification are not necessarily all referring to the same embodiment. Furthermore, the particular features, structures, or characteristics may be combined in one or more embodiments. Embodiments described herein may include machines, devices, engines, or apparatuses that operate using digital signals. Such signals may comprise electronic signals, optical signals, electromagnetic signals, or any form of energy that provides information between locations.

As mentioned previously, existing mechanisms and/or approaches useful for markets for online advertising space may produce, or result in, undesirable economic conditions for one or more market participants. For example, in accordance with an aspect of the present description it has been recognized that, in a sponsored search auction context, certain existing mechanisms and/or approaches may make it challenging for advertisers to identify keywords to bid on. In addition, these markets may have undesirable economic properties, such as the non-existence of equilibria (e.g., Nash equilibrium) that may make it challenging for an advertiser to determine how much to reasonably bid for one or more keywords. Here, in this context, the term “advertiser” is meant to refer to a person or entity that may participate directly or via another party or entity (e.g., third-party agent) in a market for online advertising space, as just an example.

In general, markets for online advertising space tend to have a simple framework. For example, in one type of market, a sponsored search auction, an advertiser specifies a query to advertise on, and submits a bid for that query representing the maximum amount that advertiser may be willing to pay. When a user's device submits a query, an auction system or market maker engine or other like process/device collects advertisers' bids for that query, and runs an auction, such as a second price auction, to determine which advertisers win and what prices each winner may be charged. Accordingly, there are usually multiple winners, as there are typically multiple slots for advertising on a search result page or other web page. A winning advertiser may then be charged, for example, in the event of a user clicking on or otherwise selecting their advertisement. Charging in the event of such user selection has been termed a so-called “pay per click” scheme.

While sponsored search auctions represent one typical market for online advertising space, in accordance with an aspect of the present description it has been recognized that there may be reason for concern with its use and the use of other like markets for online advertising space. For example, one concern that has been recognized is that certain markets tend to ignore the complexity of bidding for potential advertisers. Complexity in an online advertising market may be due, for example, to the sheer size of the market and in particular the number of different items and types of items that may be available to bid on. Here, for example, each keyword (e.g., characters, a word, or a phrase, etc.) that a user may potentially search may represent an item that may be bid on by advertisers (e.g., sold in a online advertising market). This appears to contrast with more traditional auction environments wherein, for example, the number of different items and/or types of items (or services) that are offered for sale are by comparison typically substantially less. Accordingly, in online advertising markets, it may be difficult for an advertiser to effectively evaluate the sheer number of possible items (e.g., keywords) available to bid on. Ignoring such issues of complexity may, however, may lead to inefficiencies in markets for online adverting space, such as reduced coverage for rare or unappreciated yet potentially valuable keywords, as just an example.

Approaches such as broad matching keywords have been applied to at least partially mitigate some aspects of complexity. Generally, broad matching means that when an advertiser bids on a keyword using a broad match option, a search engine, or other market maker, may apply a bid for a particular keyword to a broader set of keywords, such as keywords that may be deemed to be semantically, linguistically, or otherwise related to that particular keyword. Thus, for example, broad matching may group keywords related to a particular keyword such that a broad matched set may encompass keywords that may be plural, singular, in a different order or sequence, or have fewer or additional keywords, relative to a particular keyword, as non-limiting examples. Broad matching is thought to help advertisers to expand their bid to other potentially valuable keywords, and may help a search engine, or other market maker, to increase its keyword coverage and increase market competition (e.g., increase the number of advertisers participating in the market), which may increase its revenue.

Broad matching, however, may have undesirable economic properties, such as a reduction and/or non-existence of equilibria (e.g., Nash equilibrium) that may make it challenging for an advertiser to determine how much to bid for a broad-matched keyword. For example, apart from simple budget or capacity constraints, valuations of bidders tend to be additive, so that an advertiser's valuation for a particular set of keywords may be a product of its expected value for each, or a sample of, particular keywords in that set. Thus, an advertiser's valuation for a broad-matched set of keywords may differ from another advertiser's valuation for that particular set. Intuitively, this may be due, at least in part, to the observation that an advertiser bidding on a set of broad-matched keywords may have a different valuation for various keywords in the set.

Furthermore, an advertiser's expected value for one or more particular keywords in a broad-matched set may not reflect the fact that broad-matched keywords may overlap. That is, broad-matched keywords may be clustered such that a particular keyword may be found in two or more broad-matched sets. Hence, for example, if a competing advertiser overbids on some (but not all) keywords in a broad-matched set, this may change the valuation for the set of keywords an advertiser may receive. To illustrate, assume, for example, an auction has two advertisers, bidder 1 and bidder 2, bidding for two keywords, a and b, where a and b occur with the same frequency. Bidder 1 bids on T₁={a, b} having a value of 10 for a and 2 for b. Bidder 2 bids on T₂={a}, having a value of 7 for a. If each bidder bids truthfully according to his or her expected value for the bundle, bidder 1's bid would be (10+2)/2=6. Thus, in this illustration, bidder 1 loses in the auction for a, receiving only the keyword b which has a value of 2. It should be noted that this simple example in fact has an equilibrium strategy, where bidder 1 overbids and wins both keywords; this is not the case, however, if each bidder bids truthfully. This may result in an auction or market with no equilibrium strategy (e.g., no Nash equilibrium) and a reduction in overall social welfare, as a non-limiting example.

With these and other concerns in mind, in accordance with certain aspects of the present description, example implementations may include methods, systems, or apparatuses for implementing or supporting a market for online advertising space which may be capable of producing a dominant advertiser strategy. For example, in certain embodiments, an automated clustering engine or other like process may cluster a portion of a collection of keywords (a collection of keyword is herein represented by “K” into a plurality of keyword sets. In this context, the phrase “collection of keywords” refers to a superset of keywords from which various sets of keywords may be clustered. Here, each keyword set may be clustered so that each set is either disjoint or identical to each other keyword set for a collection of keywords. For instance, in certain embodiments, an automated clustering engine may cluster a collection of keywords such that for two keywords in that collection, keywords a and b, for example, the sets Sa and Sb are either disjoint or identical.

In addition, in certain embodiments, keyword sets may be clustered so as to obtain increased or a more desirable total social welfare for that particular set. Generally speaking, total social welfare is an efficiency indicator, which may be useful to show how efficiently keywords in an auction may be allocated to one or more bidders. Thus, in an embodiment, total social welfare may include a sum of values that all participants in an auction (e.g., advertisers, market makers, auctioneers, or the like) may receive, for example. Furthermore, in certain embodiments, advertisers may be permitted to bid only for a particular cluster and not for individual keywords. Accordingly, in various embodiments, an automated clustering engine or process, a market maker computing platform, or the like, may act to permit advertisers to place a bid for either all or none of the keywords in a particular keyword set.

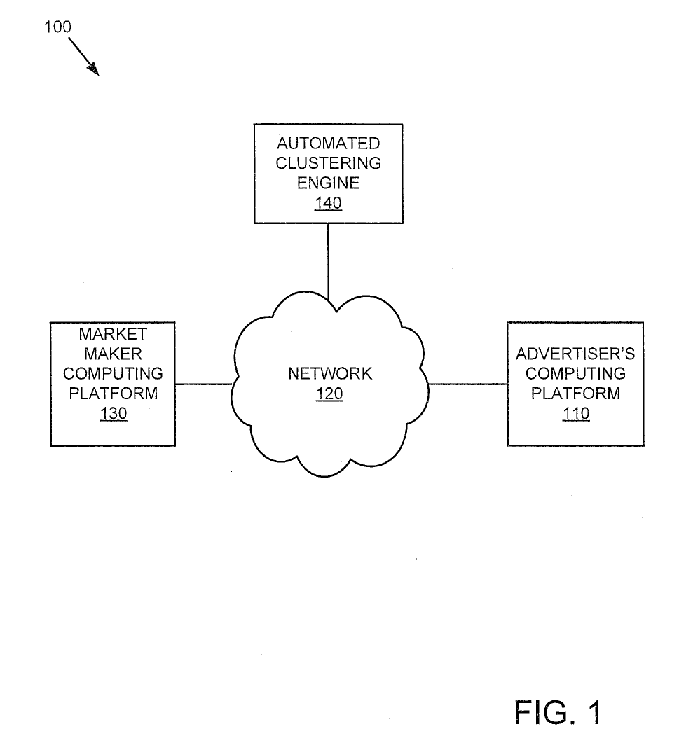

FIG. 1 is a schematic diagram depicting an embodiment of an exemplary system 100 that may be enabled to implement or otherwise support at least a portion of a market for online advertising space capable of producing a dominant advertiser strategy. In system 100, at least one computing platform 110 may be communicatively coupled to at least one network 120, such as a communications network of a plurality of networked computing platforms, for example. Here, in this example, computing platform 110 may represent one or more computing platforms associated with one or more advertisers. For example, an advertiser, such as a person, an entity, or a third-party (e.g., agent) may use computing platform 110 to submit a request for a particular keyword, as a non-limiting example. For example, an advertiser may enter or type a keyword that he or she may be interested in bidding on. In addition, this request may reflect an advertiser's desire to have a particular keyword matched with a broader set, or may request that it cover portions of a keyword, common misspellings, plurals, acronyms, abbreviations, etc., as non-limiting examples. This request may be transmitted in the form of binary digital signals via computing platform 110 to network 120.

System 100 may also include a market maker computing platform 130. Market maker computing platform 130, which may be associated with a search engine, for example, may be communicatively coupled to network 120. Market maker computing platform 130, in this example, may receive binary digital signals relating to one or more advertisers' requests for a keyword from computing platform 110 via network 120. Of course, in certain embodiments, market maker computing platform 130 may access or have stored thereon binary digital signals relating to one or more advertiser's keyword requests, which it may receive or otherwise access (e.g., via network 120) from advertiser's computing platform 110, or from other sources, as non-limiting examples.

Also, in an embodiment, market maker computing platform 130 may receive, access, or have stored thereon binary digital signals relating to keyword valuation information. Keyword valuation information may include information relating to an advertiser's expected value for one or more keywords. For example, in an embodiment, keyword valuation information may include real valuation information, estimated valuation information, and/or combinations thereof. To illustrate, real keyword valuation information may be based, at least in part, on previous or historical advertiser bid information for particular keywords, for example. Estimated valuation information may be based, at least in part, on estimates performed by an oracle or oracle-like process or machine, a natural language process, or other estimation techniques, or the like, as non-limiting examples. In certain embodiments, market maker computing platform 130 may index one or more keywords with its associated keyword valuation information.

Market maker computing platform 130 may transmit information to, access or receive information from, one or more computing platforms communicatively coupled to network 120, such as an automated clustering engine 140, or other computing platforms (not depicted). For example, in an embodiment, market maker computing platform 130 may transmit one or more signals relating to an advertiser's request for a keyword, keyword valuation information for one or more keywords, and/or other information, to automated clustering engine 140. Additionally and/or alternatively, automated clustering engine 140 may receive or access such information from various other sources, such as via other computing platforms or devices communicatively coupled to network 120, from advertiser's computing platform 110, or have such information stored thereon, as non-limiting examples.

Here, in system 100, automated clustering engine 140 may access or receive binary digital signals relating to an advertiser's request for a keyword. In response, in an embodiment, automated clustering engine 140 may produce a keyword set by clustering at least a portion of a collection of keywords K determined to be semantically, linguistically, or otherwise related to a particular keyword requested by an advertiser, for example. In certain embodiments, a particular keyword set may be clustered so that it may contain a particular keyword requested by an advertiser and one or more related keywords from the collection of keywords K.

Those skilled in the art will recognize that there are likely numerous ways or approaches that may be used by automated clustering engine 140 to determine which keywords may be related to a particular keyword an advertiser may be interested in. One approach, for example, may be to utilize an oracle or oracle-like process or machine, or natural language processing to determine a relationship between two or more keywords, as just some examples. Thus, based at least in part on one or more of these processes, a plurality of keywords forming a keyword set may be determined to be semantically, linguistically, or otherwise related, for example. So as to not obscure claimed subject, these various ways or approaches will not be discussed; however, it is to be understood that any or all such ways or approaches are included within the scope of claimed subject matter.

While keywords may be clustered in various ways, in certain embodiments, each particular keyword set may be clustered so that each set is either disjoint or identical to each other keyword set for a collection of keywords K. In other words, for a collection of keywords K, a particular keyword, “a”, may be present in only one set, Sa; alternatively, particular keyword “a” may be present in two or more identical sets.

In certain example embodiments, automated clustering engine 140 may cluster a keyword set so as to increase the total social welfare associated with that particular set. To illustrate, in an embodiment, automated clustering engine 140 may first access or otherwise receive an advertiser's keyword request, such as previously described. Next, automated clustering engine 140 may access or otherwise receive keyword valuation information for a particular keyword requested by an advertiser and keyword valuation information for one or more keywords deemed to be related to that particular keyword. As mentioned previously, keyword valuation information for a particular keyword may be indexed with its corresponding keyword.

In certain embodiments, automated clustering engine 140 may utilize keyword valuation information, in addition to keyword relationship information to cluster a keyword set which produces an increased or more desirable total social welfare for that particular set. In other words, in an embodiment, while automated clustering engine 140 may determine that a distribution of keywords D in a collection of keywords K may be related to a particular keyword, automated clustering engine 140 may select particular keywords in related distribution of keywords D based, at least in part, on their respective individual or collective keyword valuation information to produce a set with a desirable total social welfare with respect to potential sets of keywords available in a related distribution of keywords D in collection of keywords K.

For instance, keyword valuation information for a particular keyword may be denoted by v (i,j) which may be indexed with a particular keyword. Here, v (i,j) may be a value, v, such as a number or quantity, that an advertiser, i, may have for keyword j. In certain embodiments, v (i,j) may be a value based on previous or historical advertiser bids, or estimated values, for a particular keyword. Also, for illustrative purposes, it may simplify the clustering process for automated clustering engine 140 to transform v (i,j) into a value reflecting an advertiser's impression for a keyword. In practice, keyword valuations in markets for online advertising space are typically valued based at least partially on clicks and not impressions. However, click values may be transformed into impression values by multiplying each advertiser's valuation on a keyword, (or set of keywords) by a corresponding click-through rate of that particular advertiser. In this context, a click-through rate may include a quantitative measure which quantifies user selective access of a hyperlink or other user accessible navigation aids, associated with a keyword (e.g., clicking on the hyperlink associated with a keyword via a graphical user interface). Accordingly, in certain embodiments, click-through rate values may be stored, provided by advertisers, estimated, or otherwise made accessible to automated clustering engine 140.

To illustrate a clustering, assume automated clustering engine 140 may cluster a keyword set for an auction having multiple advertisers bidding for a single advertising slot. Here, also assume that advertisers have additive valuations (e.g., their value for a set of impressions is the sum of their values for individual impressions in the set). Thus, given a set of advertisers, A, and a collection of keywords, K, a distribution of related keywords D over K, and values, v (i,j) for each advertiser iεA may have for each keyword jεK and a number of clusters k, automated clustering engine 140 may compute a clustering of K into k clusters

$${S}_{j} … {S}_{k}$$

$$so that {\sum }_{r = 1}^{k} {max}_{i ∈ A} v ( i , {S}_{r} )$$

$$where v ( i , {S}_{r} ) = {\sum }_{α ∈ {S}_{r}} v ( i , a ) .$$

In the above example, the total social welfare in a single slot formulation of the clustering may be the total value obtained when each keyword is assigned to the advertiser with its maximum value, e.g., the total social welfare equals

$${\sum }_{i} {max}_{j} {M}_{ij} .$$

Thus, based on this formulation, automated clustering engine 140 may cluster so that a particular clustering for that auction may be based, at least in part, on an advertiser with respectively the largest incremental gain of social welfare. Of course, while the above illustration depicts a clustering in a setting with multiple advertisers for a single slot, this formulation of the clustering approach may be extended to a setting with multiple advertisers for multiple slots. For example, in a certain embodiments, a clustering may be based, at least in part, on a slate of advertisers that obtain the largest incremental gain in social welfare, as just an example. For example, in an embodiment, a slate of advertisers may be a plurality of advertisers k whose ads may be displayed in k ad slots on a webpage. Here, the value of this particular slate of advertisers k may be the total value of all of these advertisers for an ad slot in which their ad may be displayed, as just an example.

Thus, in certain example embodiments automated clustering engine 140 may cluster in response to a keyword request from an advertiser; however, this may not be the case in other embodiments. For example, in an embodiment, automated clustering engine 140 may predetermine a clustering for one or more keywords sets. For example, automated clustering engine 140 may choose a particular keyword in a collection of keywords K and cluster such as previously described. One advantage of predetermining a clustering may be to reduce the run time associated with a clustering process. Accordingly, in an embodiment, automated clustering engine 140 may access an oracle or oracle-like process or machine that outputs samples according to D and an oracle or oracle-like process or machine that given i and j, outputs v (i,j). Also, in an embodiment, an oracle or oracle-like process or machine outputs may be in the form of an oracle that given a keyword, may decide which cluster a keyword belongs to.

Furthermore, with respect to clustering a keyword set to approximately optimize or increase social welfare, it should be noted that there may be many ways to determine social welfare associated with a keyword set, with may take into account various factors and/or make various estimates and/or assumptions. While two formulations, a deterministic and a stochastic clustering formulation—are presented below, it is here noted that the scope of claimed subject matter is not to be limited to these two examples. In addition, as used herein, the terms maximize, optimize, and/or the like, unless already preceded by approximately and/or substantially, shall be interpreted to include this modifiers, and/or like modifiers.

In certain embodiments, for example, an (1-1/e)-approximation algorithm for a deterministic formulation of the clustering problem may be used by a clustering engine or process. A component of the solution is the definition of the function, which may be reduced to submodular function maximization. For instance, a clustering process may define a function ƒ from a domain A to a set of non-negative reals. The value of a function on a set R⊂A may be defined as follows:

$$f ( R ) = {Exp}_{j ← D} [ {max}_{a ∈ R} v ( a , j ) ] .$$

Corresponding to the set R ⊂A, |R|-clustering C_{R} of K may be defined as follows: each cluster Sₐ in C_{R} corresponds to an advertiser a in R, and each keyword jεK is assigned to the cluster corresponding to an advertiser aεargmax_{aεR} V (a,j). Note that with this definition and the definition of f, the value of f(R) may be close to or precisely the expected value of a keyword in a cluster to the advertiser in R that this cluster is assigned to, e.g.,

$$f ( R ) = {\sum }_{a ∈ R}^{Pr} {}_{j ← D} [ j ∈ {S}_{a} ] \cdot {Exp}_{j ← D \vert {S}_{a}} [ v ( a , j ) ] .$$

This implies that for each set R c A, the social welfare of the clustering C_{R} is at least f(R). Consider, for example, a set Sₐ in the clustering C_{R} and assume this set corresponds to the advertiser aεR. The expected value of the advertiser a for this cluster is

$${Exp}_{j ← D \vert {S}_{α}} [ v ( a , j ) ] .$$

Therefore, in certain embodiments, the expected value of an advertiser with a maximum value for this cluster may be at least this much. Hence, if each cluster in C_{R} is assigned to the advertiser with a maximum expected value, the resulting welfare may be at least f(R).

Note that the inequality above may sometimes be strict, e.g., the correspondence between a set R of advertisers and the clustering C_{R} may not be one-to-one. In certain embodiments, however, the correspondence between a set R of advertisers and the clustering C_{R} may be one-to-one. For instance, in certain embodiments, assume “OPT”, which may represent a one-to-one clustering, denotes a partitioning of K into at most k clusters which may potentially maximize the social welfare among such clusterings. Let R* denote a set of advertisers that win (e.g., those that may have the maximum value for) at least one cluster in OPT. Accordingly, in certain embodiments, the social welfare of the clustering OPT is f (R*).

Here, for example, the welfare of the clustering C_{R*} may be at least f (R*). On the other hand, by the definition of f if for each keyword jεK, aⱼ is the advertiser to whom j is assigned in OPT, we have

$$f ( {R}^{*} ) = {\sum }_{j ← D} [ {max }_{a ∈ {R}^{*}} v ( a , j ) ] \geq {\sum }_{j ← D} [ v ( {a}_{j} , j ) ] = O P T .$$

Therefore, OPT≦f (R*)≦welfare(C_{R*}). However, since OPT may be a one-to-one clustering, equality may be present.

Based, at least in part, on the deterministic formulation of the clustering problem, it may be evident that a c-approximation algorithm for potentially finding a maximum value of f (R*) subject to |R|≦k may provide a c-approximation algorithm for the clustering problem: the clustering may simply be C_{R*} where R* is a set that approximately maximizes f. Furthermore, the resulting clustering may be given compactly as a membership oracle: that is, for each given keyword jεK, an oracle or oracle-like process or machine may evaluate v (a,j) for aεR* and assign j to a cluster with may maximum value, for example.

In addition, in certain embodiments, j may potentially be maximized. For example, a function j may be submodular and non-decreasing, in various embodiments. Thus, a maximization approximation problem may be solved using various known or well understood approaches, such as a greedy algorithm, for example. As just an example, the greedy algorithm of G. L. Nemhauser, L. A. Wolsey, and M. L. Fisher with an approximation factor of 1-1/e., may be used in an embodiment. (see, “An Analysis of Approximations for Maximizing Submodular Set Functions” i. Math. Prog., 14:265-294, 1978). Generally speaking, this approach consists of iteratively picking an element (in this case an advertiser aεA) with the maximum marginal value.

In the case of at least one deterministic formulation of a clustering, inputs may be given using one or more oracle or oracle-like processes or machines. Accordingly, instead of computing a marginal value of each aεA in each iteration, a deterministic formulation of a clustering may use sampling, such as a sample size of O(log k) to estimate marginal values. Here, the total error may be bounded using a union bound, for example, and show that a greedy algorithm with an approximate evaluation of the marginal values may achieve an approximation factor arbitrarily close to 1-1/e. Thus, in certain embodiments, for every constant ε>0, there may be an algorithm that approximates a deterministic formulation of the clustering problem to within a factor of 1-1/e−ε. The running time of this algorithm is polynomial in |A| and k does not depend on |K|.

In certain embodiments, a stochastic formulation of a clustering may be used by a clustering engine and/or process. Here, for example, a clustering engine or process may have access to only distributional information about the values. Distribution values may include a number l of different types of advertisers, with each type t is associated with a probability pₜ, and a set of valuations v (t,j) for an advertiser of this type, which may be provided using an oracle or oracle-like process or machine as previously described in the deterministic formulation, as just an example.

In an environment with m advertisers, each having a type picked according to the probabilities pₜ, and where the type of the advertiser may determines its valuation, assume an instance of the stochastic clustering problem satisfies

$${min}_{tPt} \geq \frac{1}{c m}$$

for a constant c. A polynomial time algorithm that approximately solves this problem on such instance may have an approximation ratio of

$$\frac{1}{2} ( 1 - \frac{1}{e} ) .$$

One idea behind this algorithm is as follows: first, one or more techniques used in the deterministic formulation to reduce the problem to a submodular function maximization problem may be used. Here, however, a submodular function may be more complex: it may be a function defined on set of all permutations of advertiser types. Therefore, a greedy approximation algorithm, such as the greedy algorithm of Nemhauser et al., mentioned previously, may not be implemented in certain instances on this function in polynomial time. One way to resolve this may be to truncate the permutations and approximate the objective function by a related objective function that may be defined on a polynomial-sized space. Here, the latter objective function may be submodular, and therefore, a greedy algorithm may be used to approximately optimize this function. In addition, since the function is defined on a polynomial-sized space, each iteration of the greedy algorithm may be implemented in polynomial time by searching the space for the element with the potentially maximum marginal value.

For example, let Π denote the set of all permutations of the set of types {1, . . . , l}. For a permutation (π₁, . . . , πₗ), we define

$$\begin{matrix}{q}_{i}^{π} = Pr [ there is no bidder of type {π}_{1} , … , or {π}_{i - 1} ] \\ = {( 1 - {\sum }_{r = 1}^{i - 1} P {π}_{r} )}^{m} ,\end{matrix}$$

which may omit the superscript π when there is no ambiguity. For a keyword j and a permutation π, we define

$$v ( π , j ) = {\sum }_{i = 1}^{l} ( {q}_{i} - {q}_{i} + 1 ) v ( {π}_{i} , j ) .$$

For a collection S of permutations in Π, we define the value of this collection as follows:

$$value ( S ) = {Exp}_{j ← D π ∈ S} [ max \{ v ( π , j ) \} ] .$$

Here, one problem is to find a collection S⊂Π of size at most k that has the maximum value. This problem is hereinafter referred to as “P1”. For a collection S⊂Π and permutation π⊂S,

$$Cluster ( π , S ) = \{ j ∈ K \text{:} ∀ {π}^{′} ∈ S , v ( π , j ) \geq v ( {π}^{′} , j ) \} .$$

For simplicity, assume all values v (n,j) are distinct numbers and therefore Cluster(π, S) for π⊂S cluster the set K (if some values are tied, one can arbitrarily break the ties). Based, at least in part, on the foregoing, an argument similar to the one used in the deterministic case may be used to show that a c-approximation algorithm for P1 gives a c-approximation algorithm for the clustering problem.

For instance, denote the distribution D, restricted to the cluster Cluster(π, S) by D(π, S). The objective function may be rewritten as:

$$\begin{matrix}value ( S ) = {\sum }_{π ∈ S} {Exp}_{j ← D ( π , S )} [ v ( π , j ) ] \\ = {\sum }_{π ∈ S} {\sum }_{i = 1}^{l} ( {q}_{i} - {q}_{i + 1} ) {Exp}_{j ← D ( π , S )} [ v ( {π}_{i} , j ) ] .\end{matrix}$$

Here, let S denote a potentially optimal solution to the problem P1. Then for every πεS the value Exp_{j←D(π, S)}[V (πᵢ, j)] is a non-increasing function of i. Assuming this is not true, e.g., for some πεS and some i,

$${Exp}_{j ← D ( π , S )} [ v ( {π}_{i} , j ) ] {}_{<}^{}{Exp}{}_{j ← D ( π , S )}^{} [ v ( {π}_{i + 1} , j ) ] .$$

Then by swapping πᵢ and πᵢ₊₁, the value of the collection S may be strictly increased, contradicting its potential optimality.

With regard to truncating permutations, for a permutation π, an index i*(π) may be defined as follows: i*(π) is the largest index i for which qᵢ≧1/2.

Equivalently, it is the largest i for which

$${\sum }_{r = 1}^{i - 1} p {π}_{r} \leq 1 - {2}^{- 1 / m} .$$

### Thus,

$${v}^{′} ( π , j ) = {\sum }_{i = 1}^{{i}^{*} ( π )} ( {q}_{i} - {q}_{i + 1} ) v ( {π}_{i} , j ) .$$

Similar to the above, one may define value′ (S) and Cluster′ (π, S) and define the problem of finding a collection S that maximizes value′ (S) (herein after referred to as problem P2). Note that since elements of π that come after i*(π) do not affect the values v (π, j), problem P2 in some embodiments is equivalent to finding a collection S maximizing value′ (S) from the set Π′ of permutations (π₁, . . . , π_{S}) of subsets of {1, . . . l} satisfying

$${\sum }_{r = 1}^{s - 1} p {π}_{r} \leq 1 - {2}^{- 1 / m} .$$

Thus, any α-approximate solution S to problem P2 may also be a 2 α-approximate solution to problem P1. For example, let OPT and OPT′, respectively represent be a potentially optimal solution of problems P1 and P2, respectively. Here, assume,

$${value}^{′} ( s ) \geq \frac{1}{α} {value}^{′} ( O P T ) \geq \frac{1}{α} {value}^{′} ( O P T ) .$$

By definition of value′, it may be evident that value(S)≧value′ (S). Furthermore,

$${value}^{′} ( O P {T}^{′} ) \geq \frac{1}{2} value ( O P T ) .$$

One additional step to solve P2 may utilize a greedy submodular function maximization algorithm, such as described previously. Assuming function value′ is non-decreasing and submodular, it may be shown that the space Π′ is of polynomial size. This follows from the assumptions on the instance, such as

$${min}_{tPt} \geq \frac{1}{c m}$$

for a constant c. Therefore, the length of a permutation in Π′ is at

$$\begin{matrix}most \frac{1 - {2}^{- 1 / m}}{{min}_{tPt}} \leq c m ( 1 - {2}^{- 1 / m} ) = c m ( 1 - {e}^{- ( ln 2 ) / m} ) \leq c m \cdot \frac{ln 2}{m} \\ = c ln 2.\end{matrix}$$

Accordingly, in certain embodiments, there are at most polynomially many permutations in Π′. By searching these permutations and using sampling, such as described in the deterministic formulation, each iteration of the greedy algorithm may be solved in polynomial time.

In certain embodiments, automated clustering engine 140 may transmit one or more clustered keyword sets to market maker computing platform 130. Thus, in this example, market maker computing platform 130 may be capable of storing or transmitting one or more keyword sets and/or information associated with one or more operations via network 120 to various computing platforms. For example, market maker computing platform 130 may transmit or serve one or more keywords sets, or portions thereof, to advertiser's computing platform 110 via network 120, for example.

In certain embodiments, to describe a particular keyword cluster to an advertiser, the search engine or market maker may transmit or serve a portion of a particular keyword set, such as a representative sample, to an advertiser. In an embodiment, a sample may include a small number (e.g., one or more) of keywords in a cluster (possibly with sampling probabilities proportional to the historical query volumes) to an advertiser. Here, an advertiser may view a displayed keyword sample, which may enable the advertiser to get an accurate estimate of its value for a keyword set by evaluating the sample.

In various embodiments, an advertiser may submit a bid for a keyword set based, at least in part, on an advertiser's valuation for a sample of keywords in that keyword set. Here, market maker computing platform 130 may restrict bidding to only allow advertisers to bid for a keyword set and not for individual keywords. Thus, in this restriction, advertisers may only be allowed to place a bid for either all or none of the keywords in a cluster. Thus, in an embodiment, if an advertiser places a bid on a keyword sample, this bid may be applied to all keywords in the corresponding set.

In certain embodiments, after one or more advertisers place their bids, market maker computing platform 130 may conduct an auction, such as a second price auction, for example, for each impression that arrives. That is, as a keyword request is received, market maker computing platform 130 may run an auction between a set of bidders that have bid on that keyword set or a sample thereof.

In addition, in various embodiments, a market maker computing platform may charge one or more advertisers based on a pricing scheme. For example, in a particular embodiment, a winning advertiser may be charged an amount equal to the second highest bid for a particular keyword set: Here, the utility of an advertiser may be the expectation of the value the advertiser receives minus the price paid, where the expectation is over the random draw of a keyword from the keyword set.

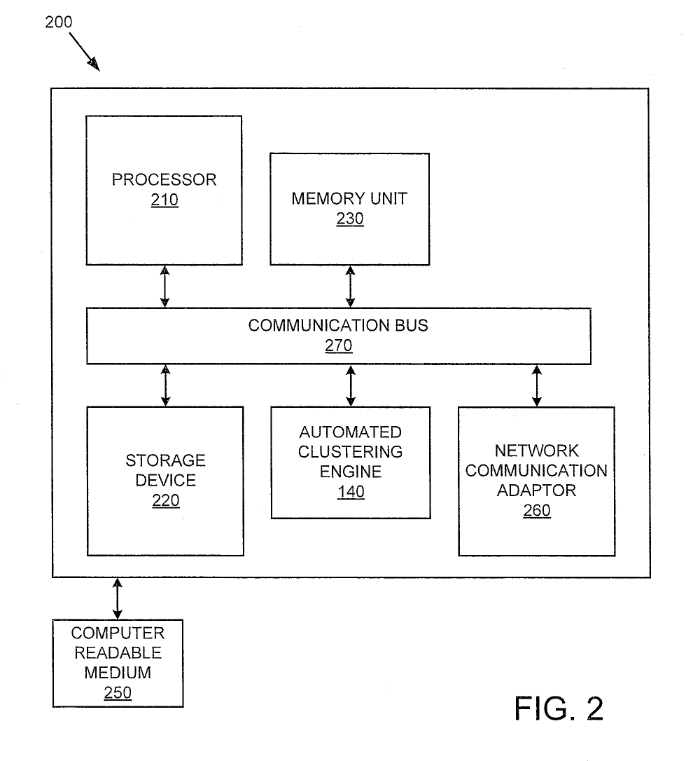

FIG. 2 is a schematic diagram depicting an embodiment of an exemplary apparatus 200 to implement or otherwise support at least a portion of a market for online advertising space capable of producing a dominant advertiser strategy. Here, apparatus 200 may include one or more special purpose computing platforms, and/or the like. In this context, the phrase “special purpose computing platform” means or refers to a computing platform once it is programmed to perform particular functions pursuant to instructions from program software. Here, apparatus 200 depicts a special purpose computing platform that may include one or more processors, such as processor 210. Furthermore, apparatus 200 may include one or more memory devices, such as storage device 220, memory unit 230, automated clustering engine 140 or computer readable medium 250. In addition, apparatus 200 may include one or more network communication adapters, such as network communication adaptor 260. Apparatus 200 may also include a communication bus, such as communication bus 270, operable to allow one or more connected components to communicate under appropriate circumstances.

In an example embodiment, communication adapter 260 may be operable to access information associated with one or more advertisers' requests for a particular keyword and/or keyword valuation information. Additionally or alternatively, such information may be stored in memory unit 230 or accessible via computer readable medium 250, for example. In addition, as non-limiting examples, communication adapter 260 may be operable to send or receive one or more signals corresponding to keyword requests or keyword valuation information, or it may be operable to send or receive one or more signals corresponding to one or more keyword sets.

In an example embodiment, automated clustering engine 140 may be operable to perform one or more processes previously described. For example, automated clustering engine 140 may be operable to access keyword requests, keyword valuation information, determine keyword sets, run an auction, determine a pricing scheme, execute a trade, or any combination thereof, as non-limiting examples.

In certain embodiments, apparatus 200 may be operable to transmit or receive information relating to, or used by, one or more process or operations via communication adapter 260, computer readable medium 250, and/or have stored some or all of such information on storage device 220, for example. As an example, computer readable medium 250 may include some form of volatile and/or nonvolatile, removable/non-removable memory, such as an optical or magnetic disk drive, a digital versatile disk, magnetic tape, flash memory, or the like. In certain embodiments, computer readable medium 250 may have stored there on computer-readable instructions, executable code, and/or other data which may enable a computing platform to perform one or more processes or operations mentioned previously.

In certain example embodiments, apparatus 200 may be operable to store information relating to, or used by, one or more operations mentioned previously, such as information relating to keyword requests or keyword valuation information, in memory unit 230 and/or storage device 220. It should, however, be noted that these are merely illustrative examples and that claimed subject matter is not limited in this regard. For example, information stored or processed, or operations performed, in apparatus 200 may be performed by other components or devices depicted or not depicted in FIG. 2. Operations performed by automated clustering engine 140 may be performed by processor 210 in certain embodiments. Operations performed by components or devices in apparatus 200 may be performed in distributed computing environments where one or more operations may be performed by remote processing devices which may be linked via a communication network, such as depicted in FIG. 1, for example.

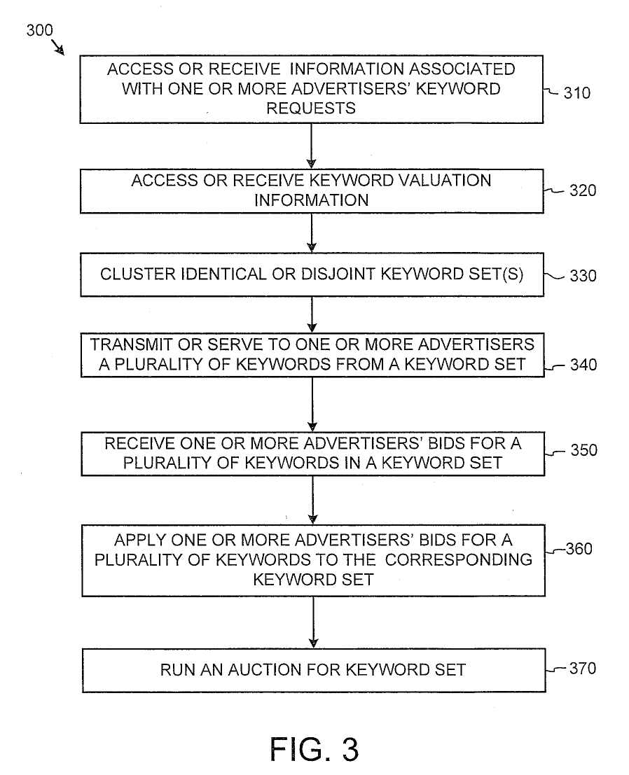

FIG. 3 is a flow chart depicting an illustrative embodiment 300 of a method for implementing or supporting a market for online advertising space capable of producing a dominant advertiser strategy. Here, at block 310, an operation or process accesses or receives information associated with an advertiser's keyword request. Next, at block 320, an operation or process accesses or receives keyword valuation information. For example, in an embodiment, keyword valuation information may include real valuation information, estimated valuation information, and/or combinations thereof.

At block 330, an operation or process may cluster one or more identical or disjoint keyword sets. For instance, a clustering process or operation may produce a keyword clustering, such as clustering a portion of a collection of keywords K believed to be semantically, linguistically, or otherwise related to a particular keyword, for example. In addition, at block 330, a process or operation may cluster keyword sets so that each particular keyword set is disjoint or identical to each other keyword set for a collection of keywords K. In other words, for a collection of keywords K, a particular keyword, “a”, may be present in only one set, Sa; or, alternatively, particular keyword “a” may be present in two or more identical sets. In addition, in various embodiments, at block 330, a process or operation may cluster a keyword set so as to increase the total social welfare associated with a particular set for a particular real or hypothetical advertiser, such as previously described.

At block 340, a process or operation may transmit (or otherwise make available) to an advertiser a plurality of keywords from a keyword set. For example, a random or semi-random sample or keywords from a keyword set may be transmitted or served to an advertiser, such as in response to an advertiser submitting a keyword request. At block 350, a process or operation may receive one or more advertiser's bids for a plurality of keywords in a keyword set. Next, at block 360, a process or operation may apply one or more advertiser's bids for a plurality of keywords to the corresponding keyword set. For instance, in an embodiment, a process or operation may calculate, based at least partially on advertiser bid values, an advertiser's value for each keyword that the advertiser bid on, such as by dividing the number of sample keywords by the total bid amount, and apply that value to the remaining keywords in a corresponding set. Of course, this is merely an example of one way in which a process or operation may apply an advertiser's bid to a corresponding set; accordingly, claimed subject matter is limited in scope to this example.

At block 370, a process or operation may execute an auction for one or more keyword sets. Here, it should be noted that there are numerous types of auctions that may be performed at block 370. As just some examples, an auction at 370 may include a second price auction, a generalized second price auction, or a laddered or double sided auctioned, just to name a few. Also, at block 370, a process or operation may charge one or more advertiser's that may have won an auction based on a pricing scheme. Here, there are numerous types of pricing schemes that may be performed at block 370. Pricing schemes at block 370 may be based on a pay-per-click or pay-per-impression system, as just two examples. Of course, as mentioned above, claimed subject matter is not to be limited to any particular examples or illustrations.

Various embodiments may have a variety of possible advantages. For instance, in a particular embodiment, a market for online advertising space may be produced which is capable of producing a dominant advertiser strategy. In an embodiment, a market may be dominant-strategy incentive compatible in the sense that for each advertiser, it may be a dominant strategy to place a bid for each cluster equal to the expected value of a keyword in that cluster (e.g., where the keyword is drawn according to a distribution D restricted to a cluster). Likewise, having a dominant strategy may make participation in the market easier for the advertiser, since it may mitigate potentially complicated and dynamic assessment of the market in order to determine an advertiser's bid. Accordingly, an in embodiment, an advertiser may assess its value for keywords in a cluster, such as its average value for keywords in a cluster, for example, and may not access its competitor's values, as just an example.

Another possible advantage of an embodiment may be that the resulting non-overlapping or wholly overlapping keyword clusters may simplify the bidding problem for advertisers. For example, non-overlapping or wholly overlapping keyword cluster may reduce the number of keywords an advertiser can bid on and simply keyword discovery. In addition, a possible advantage of an embodiment may be that non-overlapping or wholly overlapping keyword clusters may avoid the undesirable economic properties of broad matching, where advertisers can bid on overlapping sets of keywords, for example.

Another possible advantage of an embodiment may be that it may be possible to extract close to the desirable social welfare with a number of clusters considerably smaller than the number of keywords. This may, for example, avoid a non-existence of equilibria, since an advertiser may be able to determine their expected value for keywords in a cluster independent of other advertisers' bids (since other advertisers also will either bid on the whole cluster or none of it), and then bid this value if the underlying payment scheme is truthful (e.g., second price in the case of a single slot or payments substantially adhering to a Vickrey-Clark-Groves (VCG) approach for combinatorial auctions), or more generally, according to the equilibria of the mechanism in the case of a single keyword. In addition, in an embodiment, the social welfare of the clustered keyword sets may be a significant fraction (e.g., 80%) of the total social welfare, even for numbers of keyword sets that are orders of magnitude smaller than the total number of keywords.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method, comprising:
clustering a portion of a collection of keywords into a plurality of keyword sets via an automated clustering engine, wherein each keyword set of said plurality of keyword sets are either disjoint or identical with respect to each other keyword set in said plurality of keyword sets.

2. The method of claim 1, further comprising:
accessing binary digital signals associated with a request of an advertiser for a keyword, wherein said keyword corresponds at least partially to a keyword in said collection of keywords.

3. The method of claim 1, further comprising:
accessing binary digital signals associated with keyword valuation information.

4. The method of claim 1, further comprising:
providing one or more keywords from said keyword set to at least one communications network.

5. The method of claim 4, wherein said one or more keywords from a keyword set comprises a representative sample; said representative sample allowing an advertiser to assess a value, at least in part, for said keyword set.

6. The method of claim 4, further comprising:
receiving an advertiser's bid for said one or more keywords.

7. The method of claim 6, further comprising:
applying said advertiser's bid for said one or more keywords to said keyword set.

8. The method of claim 1, further comprising:
executing an auction for at least one keyword set of said plurality of keyword sets.

9. The method of claim 1, further comprising:
using a deterministic or a stochastic clustering formulation to produce at least one keyword set in said plurality of keyword sets that approximately optimizes total social welfare with respect to that keyword set.

10. The method of claim 1, further comprising:
estimating one or more values associated with keyword valuation information, at least in part.

11. The method of claim 1, wherein said portion of a collection of keywords are clustered into a plurality of keyword sets so
$${\sum }_{r = 1}^{k} {max}_{i ∈ A} v ( i , {S}_{r} ) where v ( i , {S}_{r} ) = {\sum }_{α ∈ {S}_{r}} v ( i , a ) .$$

12. An apparatus, comprising:
an automated clustering engine; wherein said automated clustering engine is operatively enabled to cluster a portion of a collection of keywords into a plurality of keyword sets for auction in an online advertising market; wherein if a portion of at least one keyword set of said plurality of keywords sets is displayed to an advertiser, enables said advertiser to formulate a truthful dominant strategy with respect to that particular keyword set.

13. The apparatus of claim 12, wherein said automated clustering engine is communicatively coupled to a network of computing platforms.

14. The apparatus of claim 12, wherein said automated clustering engine is communicatively coupled to a market maker computing platform, a server computing platform, an advertiser's computing platform, or combinations thereof.

15. The apparatus of claim 14, wherein said market maker computing platform serves said portion of at least one keyword set to a network; wherein said advertiser's computing platform is capable of receiving said portion from said network.

16. A system, comprising:
an automated clustering engine; wherein said automated clustering engine is operatively enabled to cluster a portion of a collection of keywords into a plurality of non-overlapping keyword sets; said automated clustering engine being communicatively coupled to a market maker computing platform; said market maker computing platform operatively enabled to transmit at least a portion of one keyword set of said plurality of keyword sets to a network.

17. The system of claim 16, wherein said market maker computing platform is further operatively enabled to access one or more advertiser bids associated with said at least a portion of one keyword set.

18. The system of claim 17, wherein said market maker computing platform is further operatively enabled to apply said one or more advertiser bids associated with said at least at portion of one keyword set to an entire corresponding keyword set.

19. The system of claim 16, wherein said automated clustering engine is further operatively enabled to cluster said portion of a collection of keywords into a plurality of non-overlapping keyword sets so that the total value obtained for each keyword in at least one of said non-overlapping keyword sets associated with an advertiser
$$equals { \sum }_{i} {max}_{j} {M}_{ij} .$$

20. The system of claim 16, wherein said automated clustering engine is further operatively enabled to estimate keyword valuation information.
